(19) United States
(12) Patent Application Publication
(10) Pub. No.: US 2010/0239823 A1
(43) Pub. Date: Sep. 23, 2010

(54) WINDOW FOR DISPLAY UNIT AND MOBILE TERMINAL HAVING THE SAME

(76) Inventors: Gi-Hoon THO, Seoul (KR); Jae-Wook Lee, Gwangmyeong (KR); Seung-Su Yang, Seoul (KR); Seok-Yong Park, Seoul (KR); Young-Tae Im, Anyang (KR); Min-Soo Kim, Seoul (KR)

Correspondence Address: BIRCH STEWART KOLASCH & BIRCH, PO BOX 747, FALLS CHURCH, VA, 22040-0747, US

(21) Appl. No.: 12/727,203

(22) Filed: Mar. 18, 2010

(30) Foreign Application Priority Data
Mar. 20, 2009 (KR) 10-2009-0024166

(51) Int. Cl. B32B 3/30

(52) U.S. Cl. 428/172

(57) ABSTRACT

Disclosed are a window for a display unit configured to input information in a touch manner, and a mobile terminal having the same. The window comprises a protective layer having an anti-fingerprint pattern so as to minimize fingerprints remaining thereon. The anti-fingerprint pattern minimizes fingerprints remaining on the window on which a user's finger contacts, and prevents lowering of visibility of the display unit.

### CROSS-REFERENCE TO A RELATED APPLICATION

Pursuant to 35 U.S.C. §119(a), this application claims the benefit of earlier filing date and right of priority to Korean Application 10-2009-0024166, filed on Mar. 20, 2009, the content of which is incorporated by reference herein in its entirety.

### BACKGROUND OF THE INVENTION

1. Field of the Invention

The present invention relates to a window for a display unit configured to input information in a touch manner, and a mobile terminal having the same.

2. Background of the Invention

A mobile terminal is a device that can be carried around and has one or more functions such as performing voice and video call communications, inputting and outputting information, storing data, and the like.

These various functions include video and voice call communications, still or moving images capturing using a camera, voice storing, music file reproducing through a speaker system, image or video displaying, etc. Some terminals include additional functions such as playing games, and other terminals are implemented as multimedia players. Moreover, recent terminals are configured to allow a user to view video or television programs by receiving broadcasting or multicast signals.

Various attempts have been made to implement enhanced functions of the terminal not only by structural improvements, but also by hardware or software improvements. For instance, the mobile terminal provides a user interface (UI) for allowing a user to easily and conveniently search or select desired functions.

The mobile terminal may be also provided with a touch sensor configured to directly operate a desired function selected from a plurality of functions outputted to a display. However, when a user's finger comes in contact with the display, fingerprints may remain on a window to cause the display to have a degraded appearance.

The user mainly views the display of the mobile terminal in a bright place under the sunlight or illumination, rather than in a dark place. While the light is made to be incident onto the display through the touch sensor and the window, the display may have lowered visibility due to the difference between refractive indexes of each layer.

### SUMMARY OF THE INVENTION

Therefore, an object of the present invention is to provide a window for a display unit capable of minimizing fingerprints remaining thereon and capable of preventing visibility of a display unit from being lowered, and a mobile terminal having the same.

To achieve these and other advantages and in accordance with the purpose of the present invention, as embodied and broadly described herein, there is provided a window for a display unit, comprising: a base layer; and a protective layer disposed outside the base layer, and having an anti-fingerprint pattern so as to minimize fingerprints remaining on the window, wherein the anti-fingerprint pattern comprises micro-protrusions protruding from the surface of the protective layer by a predetermined height (e) with a repeated and regular structure, and wherein a first horizontal sectional area (S1) of each micro-protrusion at a height of 1/5(e) and a second horizontal sectional area (S2) of each micro-protrusion at a height of 4/5(e) satisfy a following relation, 0.8S1<S2<S1.

The protective layer may be formed of a ultraviolet rays (UV) cure resin.

A ratio (n) of total sectional areas of lower ends of the micro-protrusions with respect to a surface area of the protective layer may be in a range of 1˜40%.

The predetermined height (e) of the protrusion may be in a range of 5 μm˜30 μm.

The protective layer may be configured such that its thickness except for the micro-protrusions is more than 9 μm.

The micro-protrusions may be configured such that an average pitch therebetween is in a range of 10 μm˜53 μm.

The protective layer may be configured such that its refractive index is in a range of 1.45˜1.59.

The window may comprise a base layer; and a protective layer disposed outside the base layer, and having an anti-fingerprint pattern so as to minimize fingerprints remaining on the window. The anti-fingerprint pattern may comprise micro-protrusions protruding from the surface of the protective layer by a predetermined height (e) with a repeated and regular structure. And, an average pitch (g; μm) between the micro-protrusions, a height (e; μm) of the micro-protrusion, and a ratio (n; %) of total sectional areas of lower ends of the micro-protrusions with respect to a surface area of the protective layer may satisfy a following relation, 15<(g×e/n)<105.

To achieve these and other advantages and in accordance with the purpose of the present invention, as embodied and broadly described herein, there is also provided a mobile terminal, comprising: a terminal body having a display mounted thereon; and a window disposed on a front surface of the display, wherein the window comprises a base layer; and a protective layer disposed outside the base layer, and having an anti-fingerprint pattern so as to minimize fingerprints remaining on the window, wherein the anti-fingerprint pattern comprises micro-protrusions protruding from the surface of the protective layer by a predetermined height (e) with a repeated and regular structure, and wherein a first horizontal sectional area (S1) of each micro-protrusion at a height of 1/5(e) and a second horizontal sectional area (S2) of each micro-protrusion at a height of 4/5(e) satisfy a following relation, 0.8S1<S2<S1.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a front perspective view of a mobile terminal having a window mounted thereon according to the present invention;

FIG. 2 is a rear perspective view of the mobile terminal of FIG. 1;

FIG. 3 is a disassembled perspective view showing a configuration of a window according to the present invention;

FIG. 4 is an enlarged perspective view of an anti-fingerprint pattern of the window according to the present invention;

FIG. 5 is an enlarged sectional view showing a state that a finger comes in contact with the surface of the window according to the present invention;

FIG. 6 is a side sectional view showing a structure and an arrangement of micro-protrusions having an anti-fingerprint pattern according to the present invention;

FIGS. 7A to 7E are views sequentially showing an anti-fingerprint pattern forming process according to the present invention;

FIG. 8 is an enlarged planar view of the anti-fingerprint pattern of the window according to the present invention;

FIGS. 9 and 10 are planar views showing another examples of the anti-fingerprint pattern according to the present invention; and

FIG. 11 is a block diagram of the mobile terminal according to the present invention.

### DETAILED DESCRIPTION OF THE INVENTION

Description will now be given in detail of the present invention, with reference to the accompanying drawings.

Hereinafter, a mobile terminal according to the present invention will be explained in more detail with reference to the attached drawings. The suffixes attached to components of the wireless speaker, such as ‘module’ and ‘unit or portion’ were used for facilitation of the detailed description of the present invention. Therefore, the suffixes do not have different meanings from each other.

A terminal may be implemented in various types. For instance, the terminal in the present description includes a mobile terminal such as a portable phone, a smart phone, a notebook computer, a digital broadcasting terminal, Personal Digital Assistants (PDA), Portable Multimedia Player (PMP), a navigation system, and a fixed terminal such as a digital TV, a desktop computer, etc. It is assumed that the terminal of the present invention is a mobile terminal. However, it will be obvious to those skilled in the art that the present invention may be also applicable to the fixed terminal, except for specific configurations for mobility.

FIG. 1 is a front perspective view of a mobile terminal having a window mounted thereon according to the present invention.

The mobile terminal 100 described in the present invention is a bar type. However, the present invention is not limited to the type, but applicable to various configurations, such as a slide type having two bodies coupled to each other to be relatively movable, a folder type, a swing type, a swivel type and the like.

A case (casing, housing, cover, etc.) forming an outer appearance of a terminal body may be formed from a front case 101 and a rear case 102. A space formed by the front case 101 and the rear case 102 may accommodate various components therein. At least one intermediate case may further be disposed between the front case 101 and the rear case 102. Such cases may be formed by injection-molded synthetic resin, or may be formed using a metallic material such as stainless steel (STS) or titanium (Ti).

On a front surface of the terminal body, may be disposed a display unit 151, an audio output module 152, a camera 121, etc.

The display unit 151 may be implemented as a liquid crystal display (LCD), an organic light emitting diode (OLED), an e-paper, etc. The display unit 151 may include a touch sensor configured to allow for an inputting operation in a tactile manner. Thus, when a point on the display unit 151 is touched, content corresponding to the touched position is inputted. The content inputted in the tactile manner may be characters, numbers, menu items that can be indicated or designated in various modes, and the like. The touch sensing unit may be light-transmissive to allow the display unit 151 to be seen, and may have a structure for enhancing visibility of the touch screen in a bright area. Referring to FIG. 1, the display unit 151 occupies most parts of a front surface of the front case 101.

At an outer side of the display unit 151, installed is a window 200 configured to protect the display unit 151 from the outside and onto which a user's finger contacts for a touch input. The window 200 is formed such that the user's fingerprints remaining thereon is minimized.

The audio output module 152 may be implemented as a receiver for transmitting a call sound to a user's ear, or a loud speaker for outputting various alarm sounds or multimedia reproduction sounds.

On a side surface of the terminal body, disposed are a side key 132, an interface unit 170, an audio input module 122, etc.

The side key 132 may be referred to as a manipulation unit, and may be configured to receive a command for controlling the operation of the mobile terminal 100. The side key 132 may include any type of side key input by a user in a tactile manner. For instance, through the side key 132, various commands may be input. The commands may include a command for controlling a video input module 125, a command for controlling sizes of sounds outputted from a video input module 152, or a command for converting a current mode of the display unit 151 into a touch recognition mode, etc.

The audio input module 122 may be implemented as a microphone so as to receive a user's voice, other sound, etc.

The interface unit 170 may generally be implemented to interface the mobile terminal 100 with external devices. For instance, the interface unit 170 may allow a data reception from an external device, a power delivery to each component in the mobile terminal 100, or a data transmission from the mobile terminal 100 to an external device. The interface unit 170 may include, for example, wired/wireless headset ports, external charger ports, wired/wireless data ports, memory card ports, ports for coupling devices having an identification module, audio Input/Output (I/O) ports, video I/O ports, earphone ports, and the like.

The identification module may be configured as a chip for storing various information required to authenticate an authority to use the mobile terminal 100, which may include a User Identity Module (UIM), a Subscriber Identity Module (SIM), and the like. Also, the device having the identification module (hereinafter, referred to as ‘identification device’) may be implemented in a type of smart card. Hence, the identification device can be coupled to the mobile terminal 100 via a port.

Also, the interface unit 170 may serve as a path for power to be supplied from an external cradle to the mobile terminal 100 when the mobile terminal 100 is connected to the external cradle or as a path for transferring various command signals inputted from the cradle by a user to the mobile terminal 100. Such various command signals or power inputted from the cradle may operate as signals for recognizing that the mobile terminal 100 has accurately been mounted to the cradle.

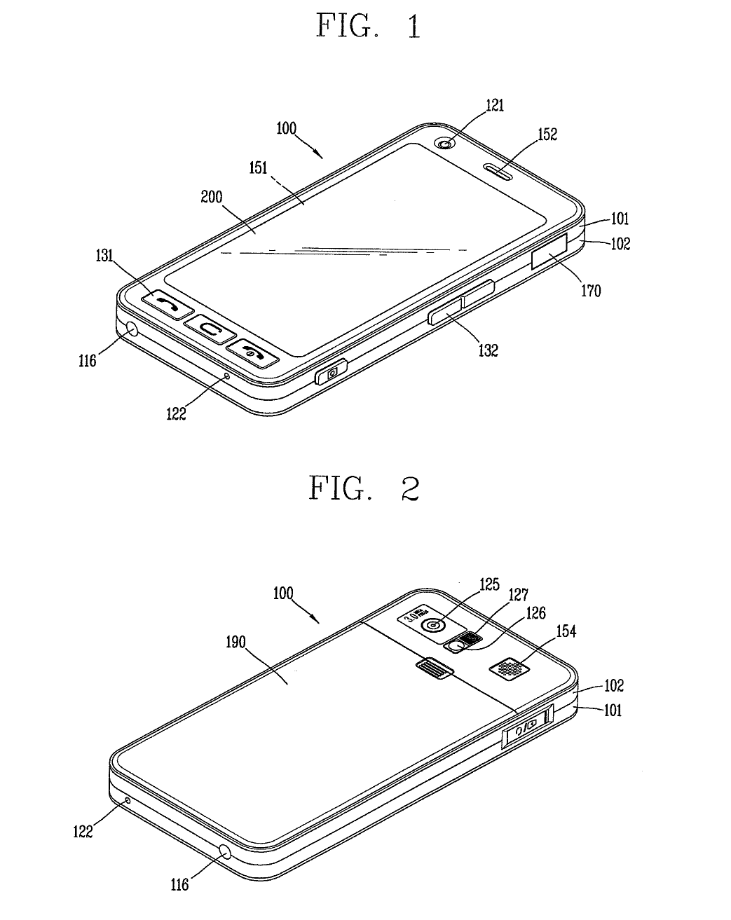

FIG. 2 is a rear perspective view of the mobile terminal of FIG. 1.

As shown in FIG. 2, a rear surface of the terminal body may further be provided with a second video input module (camera) 125. The second camera 125 faces a direction which is opposite to a direction faced by the first camera 121, and may have different pixels from those of the first camera 121.

For example, the first camera 121 may operate with relatively lower pixels (lower resolution). Thus, the first camera 121 may be useful when a user can capture his face and send it to another party during a video call or the like. On the other hand, the second camera 125 may operate with a relatively higher pixels (higher resolution) such that it can be useful for a user to obtain higher quality pictures for later use. The second camera 125 may be installed at the terminal body so as to be rotatable or pop-up.

A flash 127 and a mirror 126 may additionally be disposed adjacent to the second camera 125. The flash 127 operates in conjunction with the second camera 125 when taking a picture using the second camera 125. The mirror 126 can cooperate with the second camera 125 to allow a user to photograph himself in a self-portrait mode.

A second audio output module 154 may further be disposed on a rear surface of the terminal body. The second audio output module 154 can cooperate with the first audio output module 152 to provide stereo output. Also, the second audio output module 154 may be configured to operate as a speakerphone.

A power supply unit 190 for supplying power to the mobile terminal 100 is mounted to a rear surface of the terminal body. The power supply unit 190 may be internally mounted to the terminal body, or may be implemented as a rechargeable battery to be detachably mounted to the terminal body.

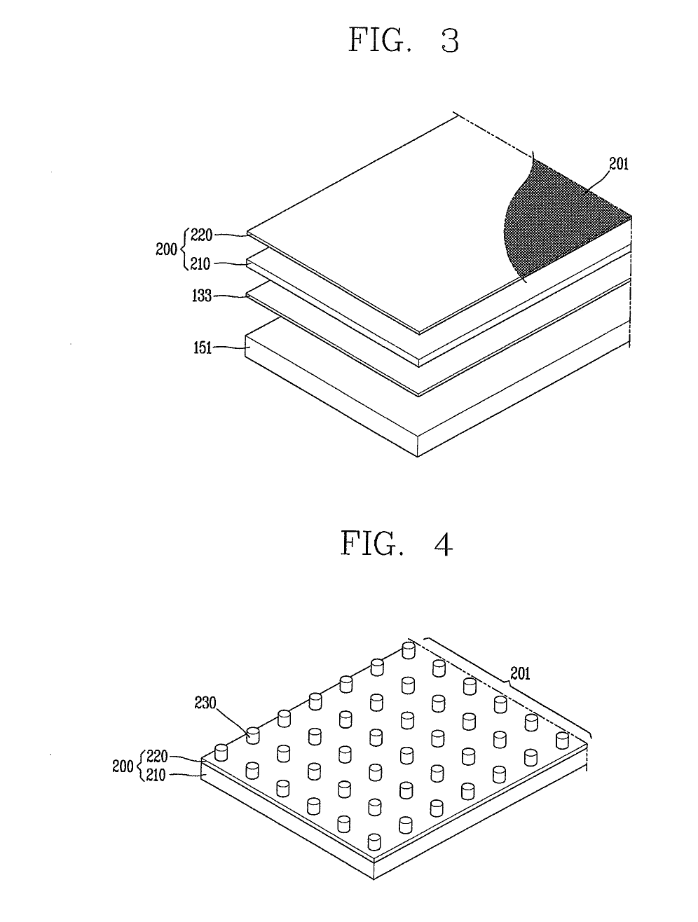

FIG. 3 is a disassembled perspective view showing a configuration of a window according to the present invention.

Referring to FIG. 3, a window 200 is mounted on the display unit 151, and a touch sensor 133 for touch recognition is mounted at an inner side of the window 200. The touch sensor 133 may be integrally attached to the window 200.

The window 200 includes a base layer 210, and a protective layer 220 formed on an upper surface of the base layer 210.

The base layer 210 is formed to protect the display unit 151, and to endure an impact or a load of the mobile terminal. Accordingly, as the base layer 210, may be used resins such as Polymethymethacrylate (PMMA), Polycarbonate (PC), and Polyethylene Terephthalate (PET), or a reinforcing glass for reducing a thickness and enhancing a strength, etc.

The protective layer 220 is formed at an uppermost layer of the window 200, and comes in contact with a user's finger for touch input. An anti-fingerprint pattern 201 having a micro structure is formed on the surface of the protective layer 220 so as to minimize fingerprints remaining on the window 200.

FIG. 4 is an enlarged perspective view of an anti-fingerprint pattern of the window according to the present invention. Referring to FIG. 4, the anti-fingerprint pattern 201 includes a plurality of micro-protrusions 230 having a repeated and regular structure. The micro-protrusions 230 prevent the user's finger from directly contacting a bottom surface of the protective layer 220, thereby minimizing the user's fingerprints remaining on the surface of the protective layer 220, and minimizing lowering of visibility of the display unit 151. Furthermore, the micro-protrusions 230 having a repeated and regular structure is optimized even at a design step so as to enhance visibility of the display unit 151 and to minimize the user's fingerprints remaining on the window 200.

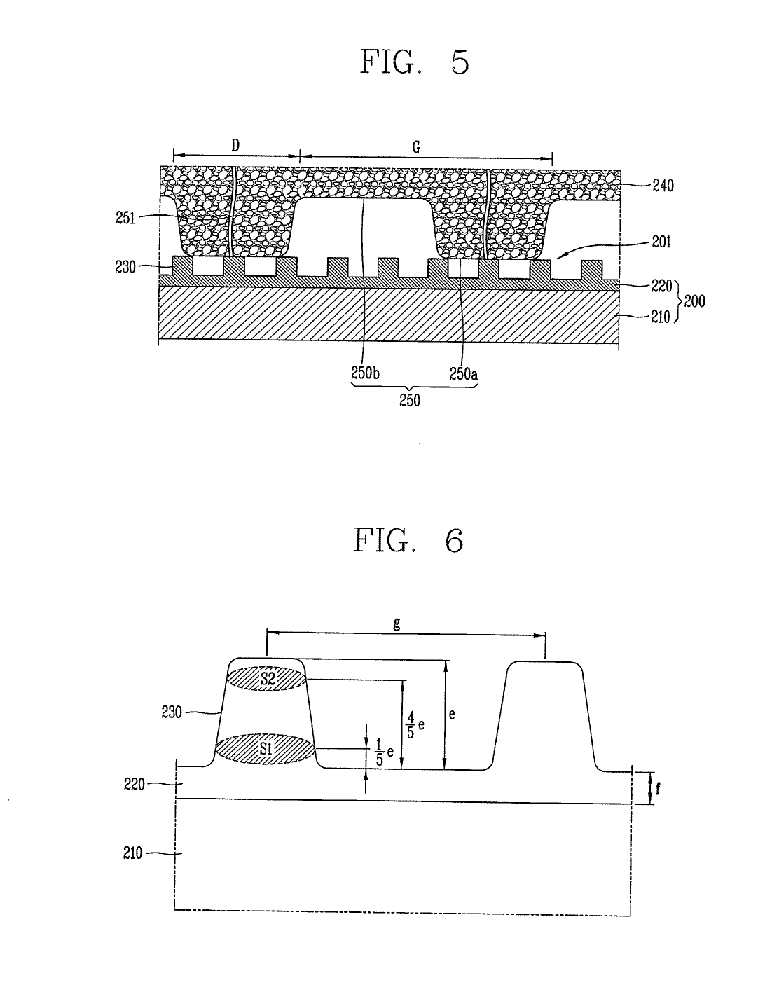

FIG. 5 is an enlarged sectional view showing a state that a user's finger comes in contact with the surface of the window according to the present invention.

As shown in FIG. 5, the surface of a finger 240 includes mountain portions 250a and valley portions 250b regularly arranged with a predetermined pitch (G) therebetween. Sweat and fattiness, main factors of the fingerprints remaining on the window are mainly discharged from sweat glands 251 formed at the mountain portions 250. Accordingly, it is necessary to prevent the mountain portions 250a having the sweat glands 251 from directly contacting a main region of the protective layer 220.

At least one micro-protrusion 230 is disposed within a width (D) of each of the mountain portions 250a. This may allow the mounting portion 250a to contact only an upper surface of the micro-protrusion 230, but prevent the mountain portion 250a from contacting other regions rather than the micro-protrusion 230. FIG. 5 shows that three micro-protrusions 230 support one mountain portion 250a.

FIG. 6 is a side sectional view showing a structure and an arrangement of micro-protrusions having an anti-fingerprint pattern according to the present invention.

A structure and an arrangement of micro-protrusions may be implemented with consideration of many factors, so as to minimize the user's fingerprints remaining on the window and to enhance visibility of the display unit 151. For instance, a larger number of the micro-protrusions 230 are preferably required to minimize the user's fingerprints remaining on the window. On the other hand, a smaller number of the micro-protrusions 230 are preferably required to minimize lowering of visibility of the display unit 151. The shape of the micro-protrusions 230 may influence on visibility of the display unit 151. For instance, when the micro-protrusion 230 has a sharp shape (e.g., corn or pyramid shape), or an irregular shape, the display may have lowered visibility. When the micro-protrusion 230 has a higher height, an identification characteristic for the user's fingerprints remaining on the window is degraded. However, in this case, the window 200 is susceptible to scratches due to an external object or impacts applied thereon.

A pitch (g) between the micro-protrusions 230 may be determined based on an average user's minimum value with consideration of a width (D) of the mountain portion 250a on which the user's finger is located. For instance, the width (D) of the mountain portion 250a on which the average user's finger is located has a minimum value of 209 μm, and a plurality of micro-protrusions 230 may be located at one mountain portion 250a.

When the micro-protrusion 230 has a very low height, foreign materials on the user's finger may contact the surface of the protective layer 220. On the other hand, when the micro-protrusion 230 has a very high height, a structure of the micro-protrusion 230 is not easily maintained due to an external friction. Accordingly, the present invention proposes the micro-protrusion 230 having a height of 5 μm˜30 μm.

A first horizontal sectional area (S1) of each micro-protrusion 230 at a height of 1/5(e) and a second horizontal sectional area (S2) of each micro-protrusion 230 at a height of 4/5(e) satisfy a following relation, 0.8S1<S2<S1. When the second horizontal sectional area (S2) is less than 0.8S1, visibility of the display unit 151 is significantly lowered. On the other hand, when the second horizontal sectional area (S2) is more than 1.0S1, it is difficult to fabricate the window, and visibility of the display unit 151 is not enhanced.

The protective layer 220 and the micro-protrusion 230 may be formed of UV cure resins.

A ratio (n) of total sectional areas of lower ends of the micro-protrusions 230 with respect to a surface area of the protective layer 220 may be in a range of 1˜40%. When the ‘n’ exceeds 40, visibility of the display unit 151 may be degraded.

A thickness of the protective layer 220 except for the micro-protrusion 230 may be 9 μm or more than. When the thickness of the protective layer 220 is less than 9 μm, a strength for supporting the protrusion is weak when a force is applied to the micro-protrusion 230 by an external friction. On the other hand, when the protective layer 220 has a thickness more than 9 μm, the protective layer 220 has a hardness different from a hardness when it has a thickness less than 9 μm, by at least one with using a hardness meter.

An average pitch between the micro-protrusions 230 is 10 μm˜53 μm. When the average pitch is less than 10 μm, the display unit 151 may have lowered visibility, and foreign materials in the air may contact the surface of the protective layer 220 (generally, when the average pitch is more than 10 μm). When the average pitch is more than 53 μm, a user's fingerprints may remain on the surface of the protective layer 220 due to downward deformation of the user's skin.

The protective layer 220 may have a refraction index of 1.45˜1.59. The entire refraction index of light is reduced by reducing a difference between a refraction index of the base layer 210. Accordingly, the refraction index of the protective layer 220 is determined with consideration of the difference. A material of the base layer 210, such as PC, PET, PMMA, and glass has a refraction index of 1.45˜1.59.

The average pitch (g) between the micro-protrusions, the height (e) of the micro-protrusion, and the ratio (n) of total sectional areas of lower ends of the micro-protrusions with respect to a surface area of the protective layer may satisfy the following relation, 15<(g×e/n)<105. Here, the ‘g’ and ‘e’ have a unit of μm, respectively, and ‘n’ has a unit of %.

When the (g×e/n) is less than 15, the display unit 151 has lowered visibility. On the other hand, when the (g×e/n) is more than 105, an anti-fingerprint characteristic is degraded.

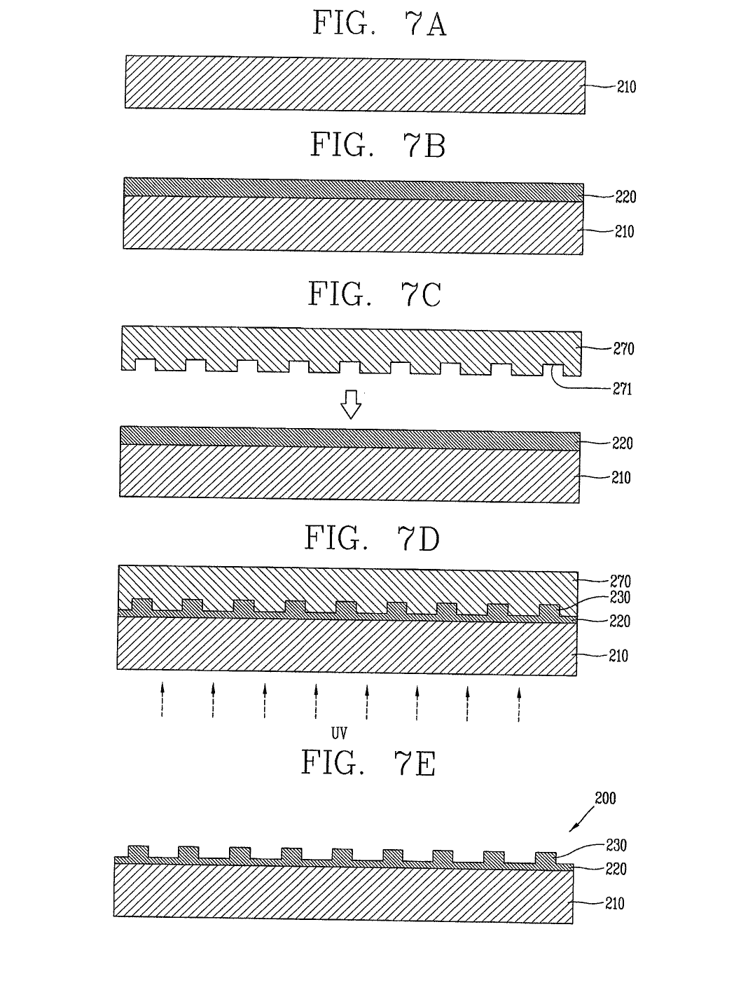

FIGS. 7A to 7E are views sequentially showing an anti-fingerprint pattern forming process according to the present invention.

Hereinafter, a method for fabricating a window according to the present invention will be explained.

As shown in FIG. 7A, prepared is the base layer 210 having a predetermined thickness and formed of PMMA, PC, PET or glass.

As shown in FIG. 7B, the protective layer 220 cured by ultraviolet rays is deposited on the surface of the base layer 210.

As shown in FIG. 7C, a mold 270 having convex-concaved patterns 271 where the micro-protrusions 230 are to be formed is made to contact the protective layer 220 with a predetermined thickness. The surface of the protective layer 220 is formed to have the same shape as the convex-concaved patterns 271 of the mold 270. And, the thickness of the protective layer 220 is influenced by a pressed degree of the mold 270.

In a state that the mold 270 is pressed by a predetermined force toward the protective layer 220 in a liquid phase, ultraviolet rays are irradiated onto the protective layer 220.

As shown in FIG. 7D, the ultraviolet rays are irradiated from a lower side of the base layer 210, i.e., an opposite side to the mold 270, for prevention of being shielded by the mold 270. Accordingly, the ultraviolet rays (UV) is transmitted to the protective layer 220 via the base layer 210, thereby curing the protective layer 220.

As shown in FIG. 7E, once the protective layer 220 is cured, the mold 270 is removed to complete the window 200.

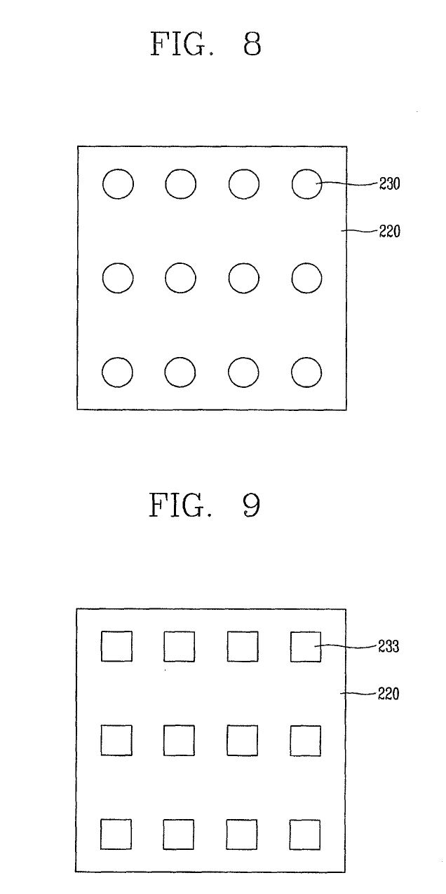

FIG. 8 is an enlarged planar view of the anti-fingerprint pattern of the window according to the present invention. FIG. 8 shows that the micro-protrusions 230 have a circular planar shape.

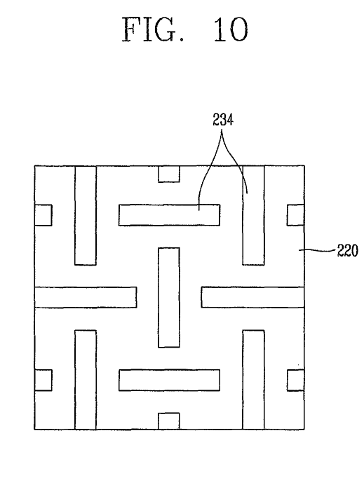

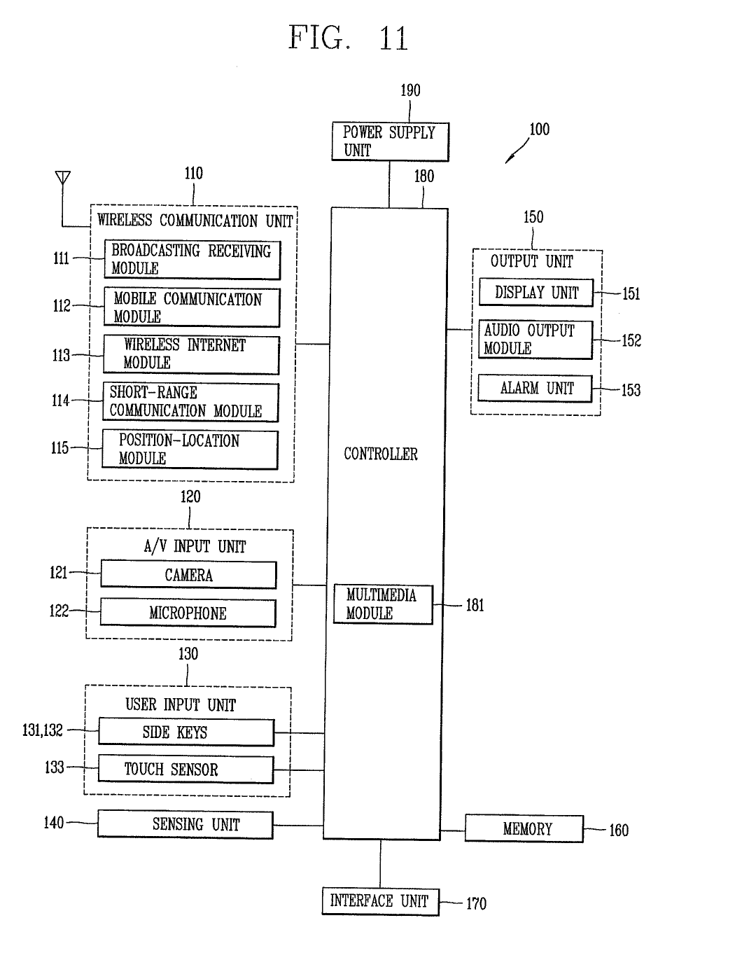

FIGS. 9 and 10 are planar views showing another examples of the anti-fingerprint pattern according to the present invention. As shown in FIGS. 9 and 10, the micro-protrusions 233 may be formed in various shapes. More concretely, the micro-protrusions 233 may be formed in a square shape as shown in FIG. 9, and may be formed in a rectangular shape as shown in FIG. 10. Alternatively, the micro-protrusions 233 may be formed in a composite shape. In this case, the aforementioned structure, pitch, etc. of the micro-protrusions may be also applied.

Under these configurations, the user's fingerprints remaining on the surface of the window can be minimized due to the anti-fingerprint pattern having regular and repeated micro-protrusions. And, lowering of visibility of the display unit can be prevented.

FIG. 11 is a block diagram of the mobile terminal according to the present invention.

The mobile terminal 100 may comprise components, such as a wireless communication unit 110, an Audio/Video (A/V) input unit 120, a user input unit 130, a sensing unit 140, an output unit 150, a memory 160, an interface unit 170, a controller 180, a power supply unit 190 and the like. FIG. 11 shows the mobile terminal 100 having various components, but it is understood that implementing all of the illustrated components is not a requirement. Greater or fewer components may alternatively be implemented.

Hereinafter, each component is described in sequence.

The wireless communication unit 110 may typically include one or more modules which permit wireless communications between the mobile terminal 100 and a wireless communication system or between the mobile terminal 100 and a network within which the mobile terminal 100 is located. For example, the wireless communication unit 110 may include a broadcast receiving module 111, a mobile communication module 112, a wireless internet module 113, a short-range communication module 114, a position location module 115 and the like.

The broadcast receiving module 111 receives a broadcast signal and/or broadcast associated information from an external broadcast managing entity via a broadcast channel. The broadcast channel may include a satellite channel and a terrestrial channel. The broadcast managing entity may indicate a server which generates and transmits a broadcast signal and/or broadcast associated information or a server which receives a pre-generated broadcast signal and/or broadcast associated information and sends them to the mobile terminal. The broadcast signal may be implemented as a TV broadcast signal, a radio broadcast signal, and a data broadcast signal, among others. The broadcast signal may further include a data broadcast signal combined with a TV or radio broadcast signal.

Examples of broadcast associated information may include information associated with a broadcast channel, a broadcast program, a broadcast service provider, and the like. The broadcast associated information may be provided via a mobile communication network, and received by the mobile communication module 112.

The broadcast associated information may be implemented in various formats. For instance, broadcast associated information may include Electronic Program Guide (EPG) of Digital Multimedia Broadcasting (DMB), Electronic Service Guide (ESG) of Digital Video Broadcast-Handheld (DVB-H), and the like.

The broadcast receiving module 111 may be configured to receive digital broadcast signals transmitted from various types of broadcast systems. Such broadcast systems may include Digital Multimedia Broadcasting-Terrestrial (DMB-T), Digital Multimedia Broadcasting-Satellite (DMB-S), Media Forward Link Only (MediaFLO), Digital Video Broadcast-Handheld (DVB-H), Integrated Services Digital Broadcast-Terrestrial (ISDB-T) and the like. The broadcast receiving module 111 may be configured to be suitable for every broadcast system transmitting broadcast signals as well as the digital broadcasting systems.

Broadcast signals and/or broadcast associated information received via the broadcast receiving module 111 may be stored in a suitable device, such as a memory 160.

The mobile communication module 112 transmits and receives radio signals to and from at least one of a base station, an external terminal and a server. Such radio signals may include a voice call signal, a video call signal or various types of data according to text/multimedia message transmission and reception.

The wireless Internet module 113 refers to a module for a wireless Internet access. This module may be internally or externally coupled to the terminal. The wireless Internet technique may include a WLAN (Wireless LAN) (Wi-Fi), Wibro (Wireless broadband), Wimax (World Interoperability for Microwave Access), HSDPA (High Speed Downlink Packet Access), etc.

The short-range communication module 114 refers to a module for short-range communication. As the short range communication technologies, Bluetooth, radio frequency identification (RFID), infrared data association (IrDA), ultra-wideband (UWB), ZigBee, etc., may be used.

The location information module 115 is a module for checking or acquiring a location (or position) of the mobile terminal. A typical example of the location information module is a GPS (Global Positioning System). According to the current technology, the GPS module 115 calculates distance information from three or more satellites and accurate time information and applies trigonometry to the calculated information to thereby accurately calculate three-dimensional current location information according to latitude, longitude, and altitude. Currently, a method for calculating location and time information by using three satellites and correcting an error of the calculated location and time information by using another one satellite. In addition, the GPS module 115 can calculate speed information by continuously calculating the current location in real time.

The A/V input unit 120 is configured to provide audio or video signal input to the mobile terminal. The A/V input unit 120 may include a camera 121 and a microphone 122. The camera 121 receives and processes image frames of still pictures or video obtained by image sensors in a video call mode or a capturing mode. The processed image frames may be displayed on a display unit 151.

The image frames processed by the camera 121 may be stored in the memory 160 or transmitted to the exterior via the wireless communication unit 110. Two or more cameras 121 may be provided according to the configuration of the mobile terminal.

The microphone 122 may receive an external audio signal while the mobile terminal is in a particular mode, such as a phone call mode, a recording mode, a voice recognition mode, or the like. This audio signal is processed into digital data. The processed digital data is converted for output into a format transmittable to a mobile communication base station via the mobile communication module 112 in case of the phone call mode. The microphone 122 may include assorted noise removing algorithms to remove noise generated in the course of receiving the external audio signal.

The user input unit 130 may generate input data inputted by a user to control the operation of the mobile terminal. The user input unit 130 may include a keypad, a dome switch, a touchpad (e.g., static pressure/capacitance), a jog wheel, a jog switch and the like.

The sensing unit 140 provides status measurements of various aspects of the mobile terminal. For instance, the sensing unit 140 may detect an open/close status of the mobile terminal, a change in a location of the mobile terminal 100, a presence or absence of user contact with the mobile terminal 100, the location of the mobile terminal 100, acceleration/deceleration of the mobile terminal 100, and the like, so as to generate a sensing signal for controlling the operation of the mobile terminal 100. For example, regarding a slide-type mobile terminal, the sensing unit 140 may sense whether a sliding portion of the mobile terminal is open or closed. Other examples include sensing functions, such as the sensing unit 140 sensing the presence or absence of power provided by the power supply unit 190, the presence or absence of a coupling or other connection between the interface unit 170 and an external device. The sensing unit 140 may include a proximity sensor.

The output unit 150 is configured to output an audio signal, a video signal or a tactile signal. The output unit 150 may include a display unit 151, an audio output module 152, an alarm 153, a haptic module 154, and the like.

The display unit 151 may output information processed in the mobile terminal 100. For example, when the mobile terminal is operating in a phone call mode, the display unit 151 will provide a User Interface (UI) or a Graphic User Interface (GUI) which includes information associated with the call. As another example, if the mobile terminal is in a video call mode or a capturing mode, the display unit 151 may additionally or alternatively display images captured and/or received, UI, or GUI.

The display unit 151 may be implemented using, for example, at least one of a Liquid Crystal Display (LCD), a Thin Film Transistor-Liquid Crystal Display (TFT-LCD), an Organic Light-Emitting Diode (OLED), a flexible display, a three-dimensional (3D) display, or the like. Some of such displays 151 may be implemented as a transparent type or an optical transparent type through which the exterior is visible, which is referred to as ‘transparent display’. A representative example of the transparent display may include a Transparent OLED (TOLED), and the like. The rear surface of the display unit 151 may also be implemented to be optically transparent. Under this configuration, a user can view an object positioned at a rear side of a terminal body through a region occupied by the display unit 151 of the terminal body.

The display unit 151 may be implemented in two or more in number according to a configured aspect of the mobile terminal 100. For instance, a plurality of the display units 151 may be arranged on one surface to be spaced apart from or integrated with each other, or may be arranged on different surfaces.

Here, if the display unit 151 and a touch sensitive sensor (referred to as a touch sensor) have a layered structure therebetween, the structure may be referred to as a touch screen. The display unit 151 may be used as an input device rather than an output device. The touch sensor may be implemented as a touch film, a touch sheet, a touch pad, and the like.

The touch sensor may be configured to convert changes of a pressure applied to a specific part of the display unit 151, or a capacitance occurring from a specific part of the display unit 151, into electric input signals. Also, the touch sensor may be configured to sense not only a touched position and a touched area, but also a touch pressure.

When touch inputs are sensed by the touch sensors, corresponding signals are transmitted to a touch controller (not shown). The touch controller processes the received signals, and then transmits corresponding data to the controller 180. Accordingly, the controller 180 may sense which region of the display unit 151 has been touched.

A proximity sensor may be arranged at an inner region of the mobile terminal 100 covered by the touch screen, or near the touch screen. The proximity sensor indicates a sensor to sense presence or absence of an object approaching to a surface to be sensed, or an object disposed near a surface to be sensed, by using an electromagnetic field or infrared rays without a mechanical contact. The proximity sensor has a longer lifespan and a more enhanced utility than a contact sensor.

The proximity sensor may include a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and so on. When the touch screen is implemented as a capacitance type, proximity of a pointer to the touch screen is sensed by changes of an electromagnetic field. In this case, the touch screen (touch sensor) may be categorized into a proximity sensor.

Hereinafter, for the sake of brief explanation, a status that the pointer is positioned to be proximate onto the touch screen without contact will be referred to as ‘proximity touch’, whereas a status that the pointer substantially comes in contact with the touch screen will be referred to as ‘contact touch’. For the position corresponding to the proximity touch of the pointer on the touch screen, such position corresponds to a position where the pointer faces perpendicular to the touch screen upon the proximity touch of the pointer.

The proximity sensor senses proximity touch, and proximity touch patterns (e.g., distance, direction, speed, time, position, moving status, etc.). Information relating to the sensed proximity touch and the sensed proximity touch patterns may be output onto the touch screen.

The audio output module 152 may output audio data received from the wireless communication unit 110 or stored in the memory 160, in a call-receiving mode, a call-placing mode, a recording mode, a voice recognition mode, a broadcast reception mode, and so on. The audio output module 152 may output audio signals relating to functions performed in the mobile terminal 100, e.g., sound alarming a call received or a message received, and so on. The audio output module 152 may include a receiver, a speaker, a buzzer, and so on.

The alarm 153 outputs signals notifying occurrence of events from the mobile terminal 100. The events occurring from the mobile terminal 100 may include call received, message received, key signal input, touch input, and so on. The alarm 153 may output not only video or audio signals, but also other types of signals such as signals notifying occurrence of events in a vibration manner. Since the video or audio signals can be output through the display unit 151 or the audio output unit 152, the display unit 151 and the audio output module 152 may be categorized into a part of the alarm 153.

The memory 160 may store a program for the processing and control of the controller 180. Alternatively, the memory 160 may temporarily store input/output data (e.g., phonebook data, messages, still images, video and the like). Also, the memory 160 may store data related to various patterns of vibrations and audio output upon the touch input on the touch screen.

The memory 160 may be implemented using any type of suitable storage medium including a flash memory type, a hard disk type, a multimedia card micro type, a memory card type (e.g., SD or DX memory), Random Access Memory (RAM), Static Random Access Memory (SRAM), Read-Only Memory (ROM), Electrically Erasable Programmable Read-only Memory (EEPROM), Programmable Read-only Memory (PROM), magnetic memory, magnetic disk, optical disk, and the like. Also, the mobile terminal 100 may operate a web storage which performs the storage function of the memory 160 on the Internet.

The controller 180 typically controls the overall operations of the mobile terminal 100. For example, the controller 180 performs the control and processing associated with telephony calls, data communications, video calls, and the like. The controller 180 may include a multimedia module 181 which provides multimedia playback. The multimedia module 181 may be configured as part of the controller 180 or as a separate component.

The controller 180 can perform a pattern recognition processing so as to recognize writing or drawing input on the touch screen as text or image.

The power supply unit 190 provides power required by various components under the control of the controller 180. The provided power may be internal power, external power, or combination thereof.

Various embodiments described herein may be implemented in a computer-readable medium using, for example, software, hardware, or some combination thereof.

For a hardware implementation, the embodiments described herein may be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, micro processors, other electronic units designed to perform the functions described herein, or a selective combination thereof. In some cases, such embodiments are implemented by the controller 180.

For software implementation, the embodiments such as procedures and functions may be implemented together with separate software modules each of which performs at least one of functions and operations. The software codes can be implemented with a software application written in any suitable programming language. Also, the software codes may be stored in the memory 160 and executed by the controller 180.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A window for a display unit of an electronic device, comprising:
a base layer; and
a protective layer disposed outside the base layer, and having an anti-fingerprint pattern that includes micro-protrusions protruding from a surface of the protective layer by a predetermined height (e) with a repeated and regular structure,
wherein a first horizontal sectional area (S1) of each micro-protrusion at a height of 1/5(e) and a second horizontal sectional area (S2) of each micro-protrusion at a height of 4/5(e) satisfy a following relation, 0.8S1<S2<S1.

2. The window of claim 1, wherein the protective layer comprises a ultraviolet (UV) cure resin.

3. The window of claim 2, wherein a ratio (n) of total sectional areas of lower ends of the micro-protrusions with respect to a surface area of the protective layer is in a range of 1˜40%.

4. The window of claim 1, wherein the predetermined height (e) of the protrusion is in a range of 5 μm˜30 μm.

5. The window of claim 1, wherein the protective layer is configured such that a thickness of the protective layer, except for the micro-protrusions, is more than 9 μm.

6. The window of claim 1, wherein the micro-protrusions are configured such that an average pitch between the micro-protrusions is in a range of 10 μm˜53 μm.

7. The window of claim 1, wherein the protective layer has a refractive index in a range of 1.45˜1.59.

8. The window of claim 1, wherein the electronic device comprises one of:
a mobile terminal comprising one of a portable phone, a smart phone, a notebook computer, a digital broadcasting terminal, a Personal Digital Assistant (PDA), a Portable Multimedia Player (PMP), a navigation system; and
a fixed terminal comprising one of a digital TV and a desktop computer.

9. A window for a display unit of an electronic device, comprising:
a base layer; and
a protective layer disposed outside the base layer, and having an anti-fingerprint pattern that includes micro-protrusions protruding from a surface of the protective layer by a predetermined height (e) with a repeated and regular structure,
wherein an average pitch (g; μm) between the micro-protrusions, a height (e; μm) of the micro-protrusion, and a ratio (n; %) of total sectional areas of lower ends of the micro-protrusions with respect to a surface area of the protective layer satisfy a following relation, 15<(g×e/n)<105.

10. The window of claim 9, wherein the electronic device comprises one of:
a mobile terminal comprising one of a portable phone, a smart phone, a notebook computer, a digital broadcasting terminal, a Personal Digital Assistant (PDA), a Portable Multimedia Player (PMP), a navigation system; and
a fixed terminal comprising one of a digital TV and a desktop computer.

11. An electronic device, comprising:
a terminal body having a display mounted thereon; and
a window disposed on a front surface of the display,
wherein the window comprises:
a base layer; and
a protective layer disposed outside the base layer, and having an anti-fingerprint pattern that includes micro-protrusions protruding from a surface of the protective layer by a predetermined height (e) with a repeated and regular structure,
wherein a first horizontal sectional area (S1) of each micro-protrusion at a height of 1/5(e) and a second horizontal sectional area (S2) of each micro-protrusion at a height of 4/5(e) satisfy a following relation, 0.8S1<S2<S1.

12. The electronic device of claim 11, wherein the protective layer comprises an ultraviolet (UV) cure resin.

13. The electronic device of claim 12, wherein a ratio of total sectional areas of lower ends of the micro-protrusions with respect to a surface area of the protective layer is in a range of 1˜40%.

14. The electronic device of claim 11, wherein the predetermined height (e) of the protrusion is in a range of 5 μm˜30 μm.

15. The electronic device of claim 11, wherein the protective layer is configured such that a thickness of the protective layer, except for the micro-protrusions, is more than 9 μm.

16. The electronic device of claim 11, wherein the micro-protrusions are configured such that an average pitch between the micro-protrusions is in a range of 10 μm˜53 μm.

17. The electronic device of claim 11, wherein the protective layer has a refractive index in a range of 1.45˜1.59.

18. The electronic device of claim 11, wherein the electronic device comprises one of:
a mobile terminal comprising one of a portable phone, a smart phone, a notebook computer, a digital broadcasting terminal, a Personal Digital Assistant (PDA), a Portable Multimedia Player (PMP), a navigation system; and
a fixed terminal comprising one of a digital TV and a desktop computer.
